(19) United States
(12) Patent Application Publication
(10) Pub. No.: US 2021/0251829 A1
(43) Pub. Date: Aug. 19, 2021

(54) WHEELCHAIR, IN PARTICULAR MANUAL WHEELCHAIR FOR BARIATRIC OR HEAVY DUTY USE

(71) Applicant: Invacare International GmbH, Witterswil (CH)

(72) Inventors: Jean-Michel RONCIN, Leymen (FR); Aurelie MINOIS, Tours (FR); Laurent DERCHE, Langeais (FR); Lukas WEBER, Basel (CH); Gustave MOOT, Apeldoorn (NL)

(21) Appl. No.: 17/251,835

(22) PCT Filed: Jun. 4, 2019
(86) PCT No.: PCT/IB2019/054634

§ 371 Date: Dec. 14, 2020

(30) Foreign Application Priority Data
Jun. 14, 2018 (EP) 18177703.8
Jun. 14, 2018 (EP) 18177705.3

(51) Int. Cl. A61G 5/10; A61G 5/14; A61G 5/08

(52) U.S. Cl. CPC A61G 5/1078; A61G 5/1054; A61G 2200/16; A61G 5/14; A61G 5/0866; A61G 5/1089

(57) ABSTRACT

There is described a wheelchair, in particular a manual wheelchair for bariatric or heavy-duty use, that includes a wheelchair chassis, a seating area, a backrest, as well as front wheels and rear wheels, said backrest having a backrest frame supported onto the wheelchair chassis. The wheelchair further includes a rolling support structure forming an integral part of the wheelchair, which rolling support structure is mounted on a rear portion of the wheelchair to support the wheelchair in an upright position in which the wheelchair is tilted back and is supported by the rolling support structure to allow displacement of the wheelchair in the upright position. The rolling support structure includes at least three, in particular four, rolling elements providing rolling support for the wheelchair in the upright position. The rolling elements preferably provide omnidirectional rolling support for the wheelchair in the upright position, and may in particular be ball casters

### TECHNICAL FIELD

The present invention generally relates to a wheelchair, in particular a manual wheelchair intended for bariatric or heavy-duty use, also referred to as bariatric wheelchair or heavy-duty wheelchair.

### BACKGROUND OF THE INVENTION

Bariatric wheelchairs are known as such in the art and are typically based on enlarged, more robust iterations of conventional wheelchairs. Typical bariatric wheelchairs are in essence widened versions of conventional wheelchairs with larger seating areas and reinforced chassis structure designed to cope with the inherent requirements that come with increased load.

As a matter of fact, when it comes to the design of bariatric wheelchairs, little consideration has been given (so far at least) to comfort for the patient, wheelchair use and handling, as well as aesthetics. As a matter of fact, known bariatric wheelchairs provide limited comfort for the patient, are more difficult to use and handle than conventional wheelchairs, are visually bulky and have too much of a “medical” look, and the aesthetics thereof could accordingly be greatly improved.

FIG. 11 is a greyscale photographic illustration of a conventional bariatric wheelchair as sold for instance by Invacare® Corporation under the product designation Invacare 9000 Topaz™, which bariatric wheelchair is typically available with a seating width ranging from 20 to 30 inches (i.e. approx. 500 millimeters to 760 millimeters) and has a weight capacity exceeding 250 kg.

US Patent Publication No. US 2014/0252747 A1 discloses wheelchair designs and enhancements for use with conventional wheelchair designs, including bariatric extension panels allowing extension and widening of the seating area if need be. The proposed wheelchair designs are especially intended to be used in high security areas (such as prisons and psychiatric wards) and are therefore ill-suited for more conventional, day-to-day uses.

European Patent Publication No. EP 1 205 172 A2 discloses a transportable wheelchair positioning system of the type used to elevate and incline wheelchairs. This transportable wheelchair positioning system is separate from the wheelchair as such and configured to be selectively coupled to a rear portion of the wheelchair to elevate and incline the wheelchair backwards for the purpose of positioning a handicapped person seated in the wheelchair at different degrees of inclination and/or elevation.

There is therefore a need for an improved wheelchair design that is more suited for bariatric patients.

### SUMMARY OF THE INVENTION

A general aim of the invention is to provide a wheelchair, which improves comfort for bariatric patients as well as handling of the wheelchair by such population of wheelchair users.

A further aim of the invention is to provide such a wheelchair that exhibits a more aesthetically pleasing appearance.

Yet another aim of the invention is to provide such a wheelchair that is both lighter and easier to handle, but which does not compromise robustness.

Still another aim of the invention is to provide such a wheelchair that can be more easily handled and transported by bariatric patients, in particular through narrow passages like doorways or elevators.

These aims are achieved thanks to the solutions defined in the claims.

In accordance with the invention, there is provided a wheelchair as defined in claim 1, in particular a manual wheelchair for bariatric or heavy-duty use, comprising a wheelchair chassis, a seating area provided on the wheelchair chassis, a backrest supported onto the wheelchair chassis, as well as front wheels and rear wheels provided on the wheelchair chassis to allow wheeling of the wheelchair. According to the invention, the wheelchair further comprises a rolling support structure forming an integral part of the wheelchair, which rolling support structure is mounted on a rear portion of the wheelchair to support the wheelchair in an upright position in which the wheelchair is tilted back and is supported by the rolling support structure to allow displacement of the wheelchair in the upright position, which rolling support structure includes at least three rolling elements providing rolling support for the wheelchair in the upright position. Preferably, the rolling support structure includes four rolling elements.

The rolling elements preferably provide omnidirectional rolling support for the wheelchair in the upright position and may in particular advantageously be ball casters.

In accordance with a preferred embodiment of the invention, at least part, especially all, of the rolling elements are supported onto the wheelchair chassis.

According to a particularly advantageous embodiment of the invention, in the upright position of the wheelchair, the rear wheels do not rest on the ground, each rear wheel being preferably mounted on the wheelchair chassis by means of a quick-release mechanism.

By way of preference, the rolling support structure is at least partly deployable between a storage position at a rear portion of the wheelchair chassis and a working position where the rolling elements are fully deployed to provide rolling support for the wheelchair in the upright position.

The rolling elements may furthermore include at least a pair of lower rolling elements that also act as anti-tip devices.

In accordance with a particularly preferred embodiment of the invention, a front-to-rear position of a rear-wheel axis of the rear wheels along the wheelchair chassis is adjustable and the rolling support structure is mounted in such a way that any adjustment of the front-to-rear position of the rear-wheel axis of the rear wheels leads to a corresponding adjustment of a front-to-rear position of the rolling support structure. In this context, the rolling support structure may in particular be mounted in a fixed relationship with respect to the front-to-rear position of the rear wheel axis.

In accordance with yet another preferred embodiment of the aforementioned wheelchairs, the wheelchair chassis is designed as a rigid, non-foldable chassis and is made of lightweight materials, in particular aluminum. In this context, the backrest may advantageously be foldable frontward onto the seating area.

More particularly, the wheelchair chassis may be designed as a rigid, non-foldable chassis comprising side frames provided on left and right sides of the wheelchair chassis, each comprising a rear wheel support to support a corresponding one of the rear wheels at a position defining the rear-wheel axis, a front-to-rear position of the rear wheel support along each side frame, and therefore the front-to-rear position of the rear-wheel axis, being adjustable. In this particular context, the rolling support structure can be mounted in a fixed relationship with respect to the front-to-rear position the rear-wheel axis.

In the context of this aforementioned embodiment, the rolling support structure may be mounted directly onto the rear wheel supports or onto a rear cross member of the wheelchair chassis, which rear cross member is interposed between the rear wheel supports.

In accordance with another aspect of the invention, the backrest may advantageously exhibit a lower backrest portion supported onto the wheelchair chassis, next to the seating area, the seating area and lower backrest portion having a first width that is selected to accommodate a wheelchair user's hips. In accordance with this other aspect of the invention, the backrest further exhibits an upper backrest portion, in the vicinity of the wheelchair user's shoulders, having a second width that is smaller than the first width, which second width is selected to liberate space for movement of the wheelchair user's arms and shoulders.

By way of preference, the first width is selected to accommodate a wheelchair user's nominal hip width ranging between 500 millimeters and 800 millimeters and the second width is selected so as not to exceed a wheelchair user's nominal shoulder articulation width ranging between 400 millimeters and 600 millimeters. In accordance with a particularly preferred embodiment, the second width does not exceed 500 millimeters and the first width is selected to exceed 500 millimeters.

The backrest may advantageously comprise a backrest frame acting as structural element of the backrest, which backrest frame is shaped to exhibit lower and upper frame portions supporting respectively the lower and upper backrest portions. In this context, the backrest frame preferably includes a pair of back canes having lower ends supported onto the wheelchair chassis and being separated by the first width, which back canes are curved inwardly so that upper ends thereof, in the vicinity of the wheelchair user's shoulders, are separated by the second width.

According to another aspect of the present invention, the wheelchair may further comprises a pair of removable front canes supported into corresponding sockets provided on the wheelchair chassis next to a front part of the seating area, which pair of removable front canes can take at least a first position in which the removable front canes act as transfer aid devices to assist the wheelchair user in raising up from or, conversely, sitting onto the seating area of the wheelchair, each removable front cane exhibiting a handle portion that is oriented frontward, in the first position. By way of preference, the removable front canes are reversible and can take at least a second position, opposite to the first position, with the handle portion being oriented rearward, to act as forearm supports for the wheelchair user.

Further advantageous embodiments of the invention are discussed below.

### BRIEF DESCRIPTION OF THE DRAWINGS

Other features and advantages of the present invention will appear more clearly from reading the following detailed description of embodiments of the invention which are presented solely by way of non-restrictive examples and illustrated by the attached drawings in which:

FIGS. 1A and 1B are greyscale perspective views, respectively from the front and the rear, of a wheelchair in accordance with a first embodiment of the invention;

FIGS. 2A and 2B are black-and-white perspective views corresponding respectively to FIGS. 1A and 1B;

FIG. 2C is a perspective frontal view of the wheelchair of FIGS. 2A-2B;

FIG. 2D is a perspective view of the wheelchair of FIGS. 2A-2B as seen from the right-hand side;

FIG. 2E is a perspective view of a cross-section of the wheelchair of FIGS. 2A-2B as seen from the same perspective as FIG. 2D, which cross-section is taken along a median plane A-A as depicted in FIG. 2C;

FIG. 3A is a perspective view of the wheelchair of FIGS. 2A-2B as seen from the same perspective as FIG. 2A, where the seat upholstery, backrest trim and wheelchair cushions have been omitted;

FIG. 3B is a perspective view of the wheelchair of FIG. 3A as seen from the right-hand side, like FIG. 2D;

FIG. 3C is a perspective view of a cross-section of the wheelchair of FIG. 3A as seen from the same perspective as FIG. 3B, which cross-section is taken along the same median plane A-A as depicted in FIG. 2C;

FIG. 3D is a partial perspective view of the cross-section of FIG. 3C taken from a different perspective and focusing on a rear wheel support region of the wheelchair;

FIG. 4 is a perspective view of the wheelchair chassis and backrest frame of the wheelchair of FIGS. 2A-2E;

FIG. 5A is a side view of the wheelchair chassis of FIG. 4 taken from the left-hand side;

FIGS. 5B and 5C are enlarged partial side views of a rear portion of the wheelchair chassis shown in FIG. 5A highlighting operation of a deployable rolling support structure forming an integral part of the wheelchair, which rolling support structure is mounted on the rear-end of the wheelchair chassis;

FIG. 5D is a view of the wheelchair of FIGS. 2A-2E, with folded backrest, sitting in an upright position in which the wheelchair is tilted back and is supported by the deployed rolling support structure;

FIGS. 6A and 6B are respectively a perspective view and a front view of a backrest frame forming part of the backrest of the wheelchair of FIGS. 2A-2E;

FIG. 6C is a side view of the backrest frame of FIGS. 6A-6B taken from the right-hand side;

FIGS. 7A and 7B are schematic perspective views illustrating a backrest design in accordance with a preferred aspect of the invention and highlighting the resultingly improved hand rim accessibility of the wheelchair;

FIG. 7C is a schematic anatomic view of an overweight person and highlighting relevant morphologic characteristics that are preferably taken into consideration for the design of the backrest of the wheelchair;

FIGS. 8A and 8B are schematic side views of the wheelchair seating area highlighting a preferred backrest profile accommodating distinct wheelchair user morphologies;

FIGS. 9A to 9C are schematic side views of the wheelchair of FIGS. 2A-2E highlighting a pair of reversible front canes provided at the front of the wheelchair chassis and used, in a first position thereof shown in FIGS. 9A and 9B, as devices to assist the wheelchair user in raising up from or, conversely, sitting onto the seating area of the wheelchair and, in second position shown in FIG. 9C, as forearm supports;

FIGS. 10A to 100 are respectively a perspective view and two cross-sectional views of a wheelchair in accordance with another embodiment of the invention; and

FIG. 11 is a greyscale photographic illustration of a conventional bariatric wheelchair as sold for instance by Invacare® Corporation under the product designation Invacare 9000 Topaz™.

### DETAILED DESCRIPTION OF EMBODIMENTS OF THE INVENTION

The present invention will be described in relation to various illustrative embodiments. It shall be understood that the scope of the invention encompasses all combinations and sub-combinations of the features of the wheelchair disclosed herein.

As described herein, when two or more parts or components of the wheelchair are described as being connected, secured or coupled to one another, they can be so connected, secured or coupled directly to each other or through one or more intermediary parts.

The expression “manual wheelchair” as used herein is intended to refer to a wheelchair that can be wheeled manually by the user. This expression also encompasses power-assisted manual wheelchairs that are additionally provided with means to assist propulsion.

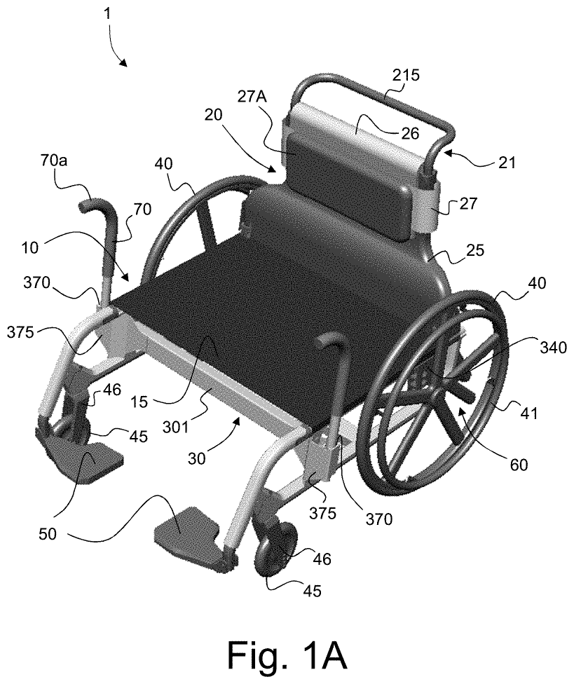

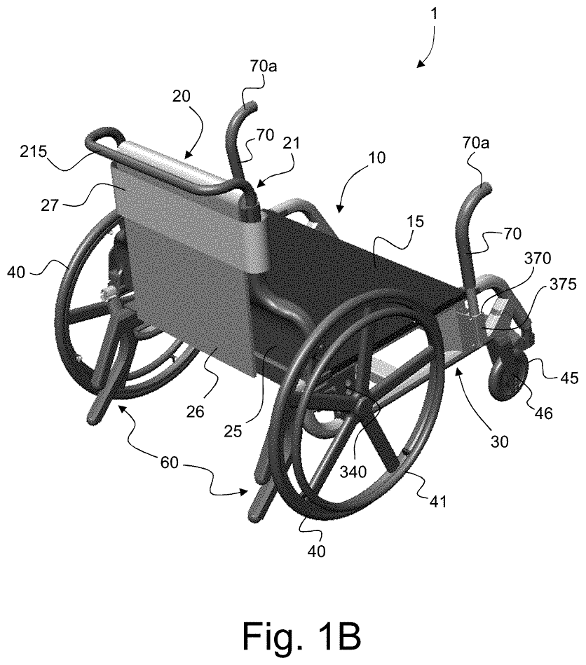

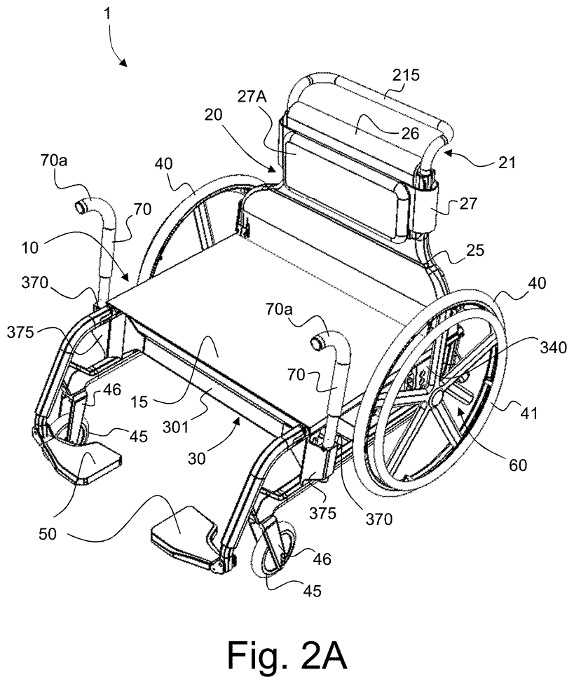

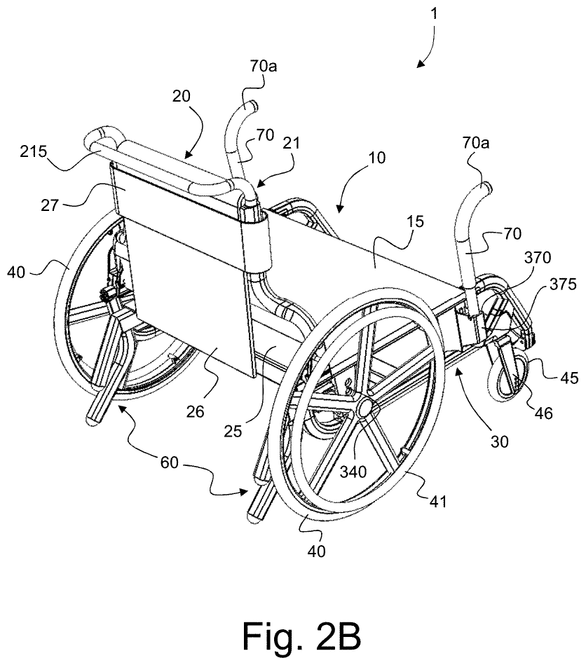

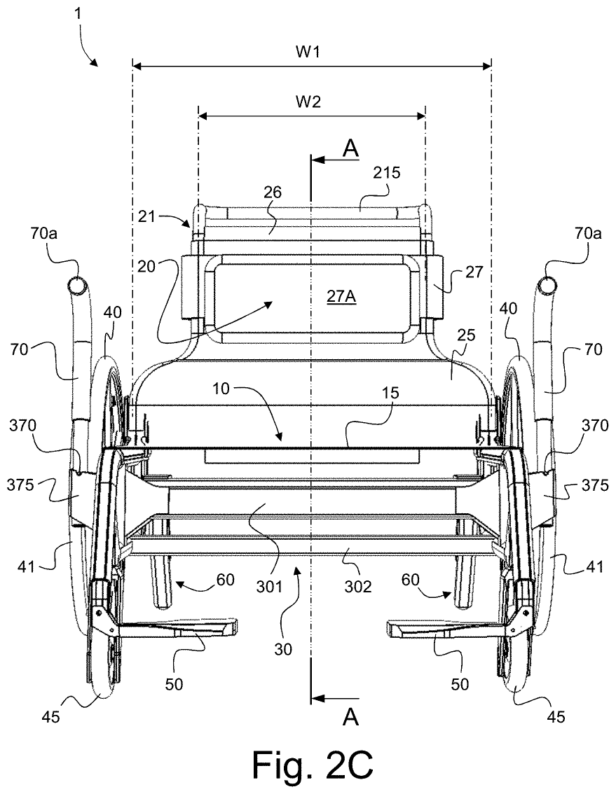

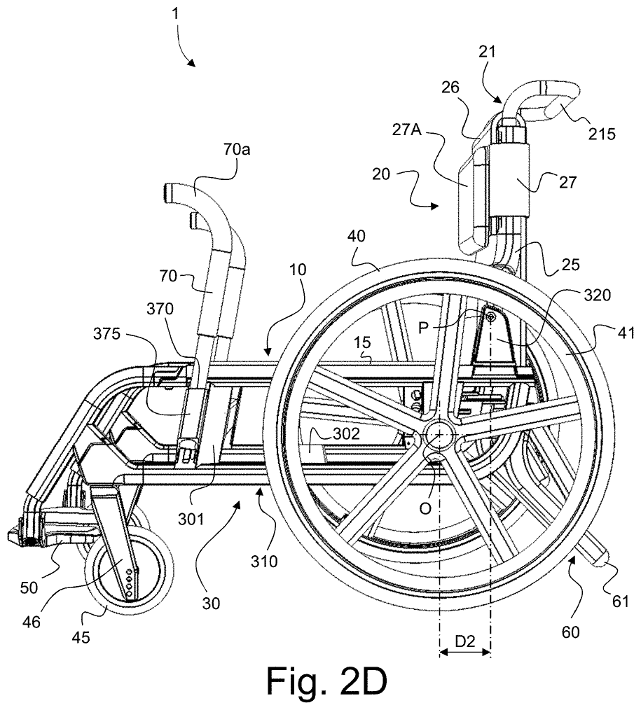

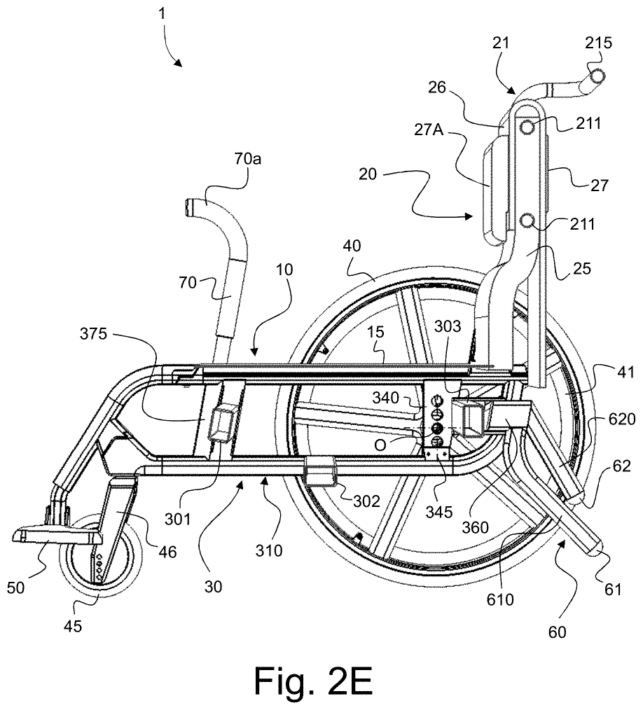

Referring to FIGS. 1A and 1B, there is shown a bariatric (or heavy-duty) wheelchair designated generally by reference numeral 1 in accordance with a first embodiment of the invention. FIGS. 1A and 1B are greyscale perspective views, respectively from the front and from the rear, of the wheelchair 1. FIGS. 2A and 2B are black-and-white perspective views of the wheelchair 1 (without shadings) corresponding respectively to FIGS. 1A and 1B. FIGS. 2C and 2D are respectively a perspective frontal view of the wheelchair 1 and a perspective view of the wheelchair 1 as seen from the right-hand side. FIG. 2E, on the other hand, is a perspective view of a cross-section of the wheelchair 1 as seen from the same perspective as FIG. 2D, which cross-section is taken along a median plane A-A as depicted in FIG. 2C.

The wheelchair 1 comprises a wheelchair chassis 30, a seating area 10 provided on the wheelchair chassis 30, a backrest 20 supported onto the wheelchair chassis 30, as well as front wheels 45 and rear wheels 40 provided on the wheelchair chassis 30 to allow wheeling of the wheelchair 1, as is typical in the art. The wheelchair 1 may optionally, but preferably, be equipped with a pair of footrests 50, known as such in the art, that are mounted on a front end of the wheelchair chassis 30.

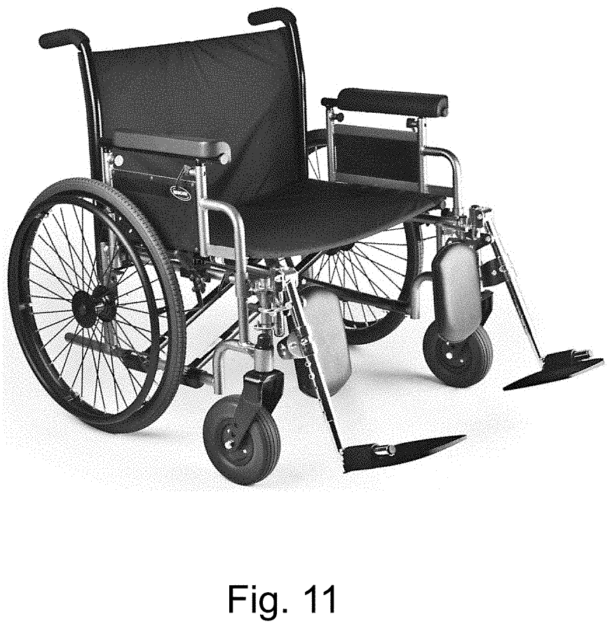

Further elements (not shown in the illustrations) could be provided, including armrests and/or elbow supports to provide support for the wheelchair user's arms or elbows, as well as clothing guards or like protective panels interposed between the rear wheels 40 and the seating area 10 to prevent clothing from getting stuck or caught in the rear wheels 40. This being said, armrests or armpads as found typically on conventional wheelchairs (see e.g. FIG. 11) could in effect be detrimental in that they potentially interfere with a proper handling and driving of the wheelchair by the wheelchair users. In that respect, it may be preferable not to equip the wheelchair of the invention with any armrest or armpad at all.

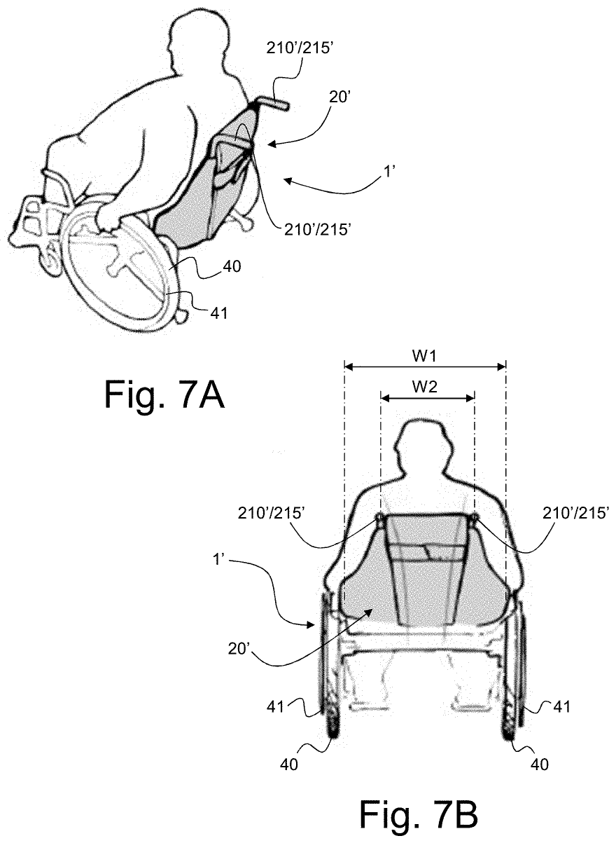

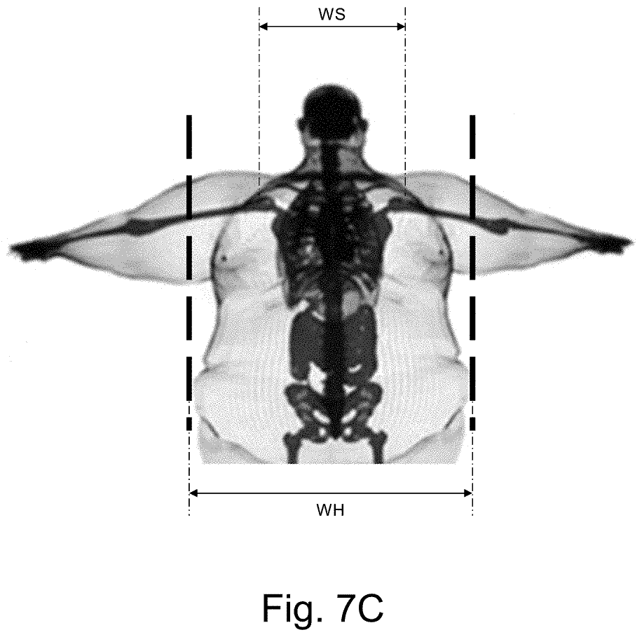

The rear wheels 40 are each typically equipped with a hand rim 41 allowing the wheelchair user to wheel the wheelchair 1 in any desired direction as is known in the art (see also FIG. 7A which illustrates handling and wheeling of a wheelchair 1′ in accordance with a particularly preferred embodiment of the present invention). The front wheels 45, on the other hand, are mounted on the wheelchair chassis 30 so as to pivot about a vertical axis, here by means of a pair of front wheel supports (or forks) 46.

In the illustrated example, the wheelchair chassis 30 is designed as a rigid, non-foldable chassis and is preferably made of lightweight materials, in particular aluminum. While a foldable chassis could in theory be contemplated within the context of the present invention (see e.g. International Publication No. WO 2014/020377 A1, the disclosure of which is incorporated herein by reference), the necessary structural elements to allow the chassis to be foldable would inherently increase weight, which is counterproductive for application as a bariatric wheelchair.

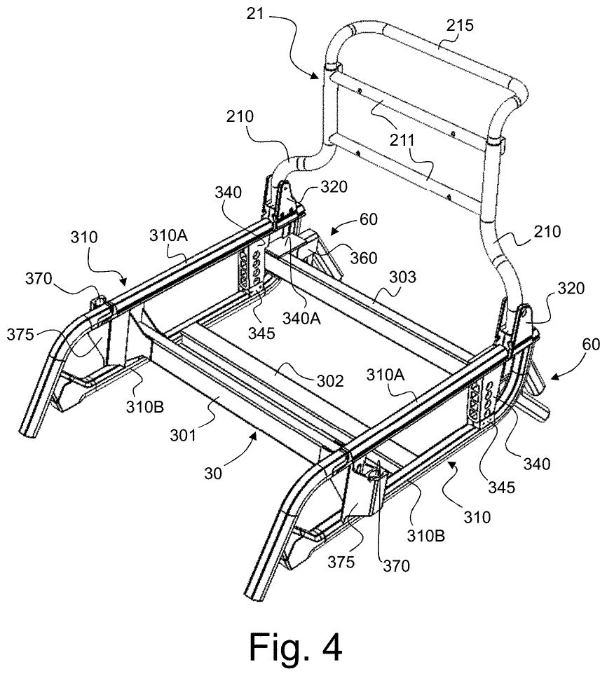

By way of preference, the wheelchair chassis 30 therefore exhibits a rigid construction (as depicted e.g. in FIG. 4) with a pair of side frames (partly visible in FIGS. 1A-1B and 2A-2E and designated in the following by reference numeral 310), on the left and right sides of the wheelchair chassis 30, each supporting a rear wheel 40 and front wheel 45, which side frames 310 are connected together by means of a plurality of cross members (also partly visible in FIGS. 1A-1B and 2A-2E and designated in the following by reference numerals 301, 302 and 303).

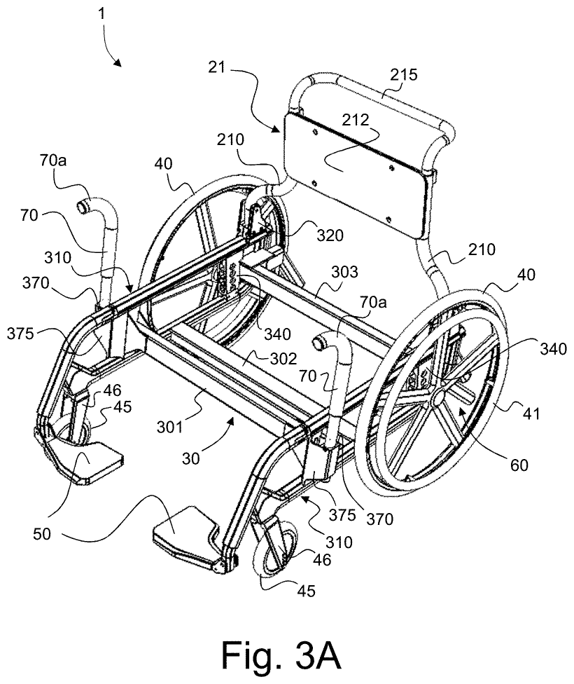

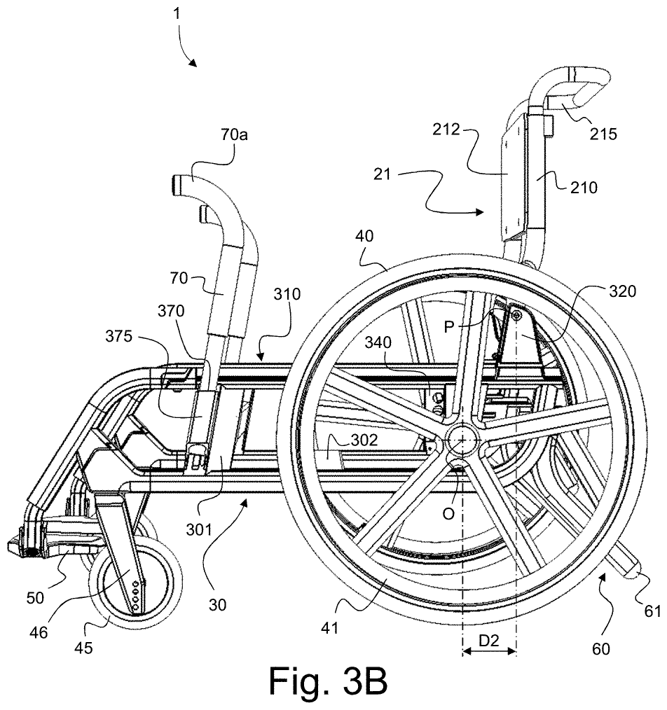

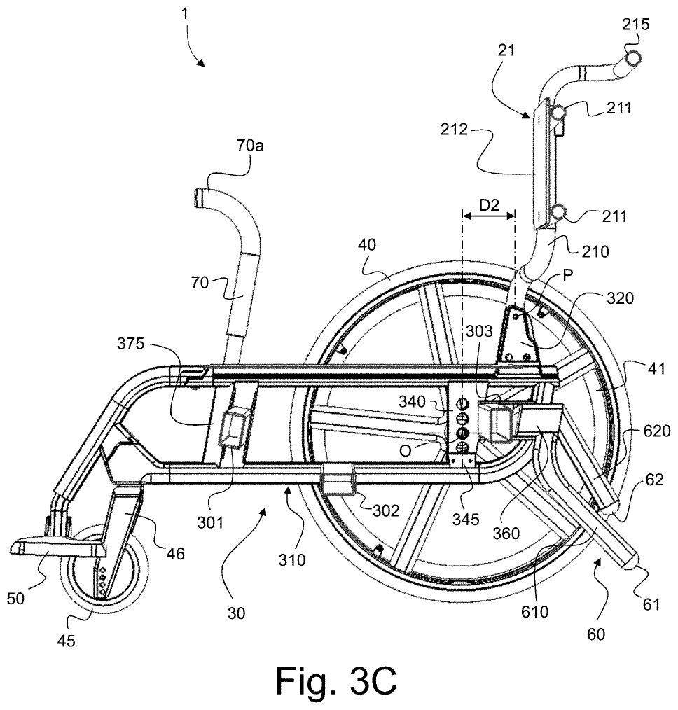

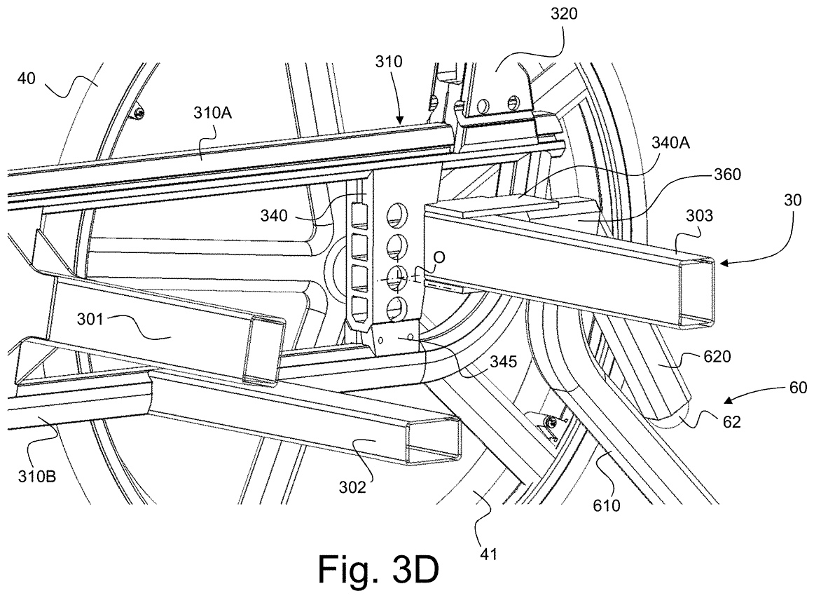

In the illustrated example, cross member 301 is provided at a location of the wheelchair chassis 30 corresponding basically to a front part of the seating area 10, while cross member 302 is provided in a middle portion of the wheelchair chassis 30, under the seating area 10, and cross member 303 is provided at a rear portion of the wheelchair chassis 30. A particularly preferred configuration of the wheelchair chassis 30 will be detailed further below with reference to FIGS. 3A-3D, 4 and 5A-5D.

Turning to the seating area 10, a self-supporting seat upholstery 15 is provided on the wheelchair chassis 30, which seat upholstery 15 consists of a sheet of resistant material adapted to suitably support a wheelchair user, such as vinyl or nylon material. In the present instance, the seat upholstery 15 is supported onto the upper portion of the wheelchair chassis 30, namely between a pair of upper frame members 310A (see e.g. FIGS. 3D, 4 and 5A) each forming a part of the side frames 310. Any other suitable seating area configuration could be contemplated within the scope of the present invention, and the particular seating area configuration illustrated in FIGS. 1A-1B and 2A-2E is only illustrative of a possible, non-limiting configuration.

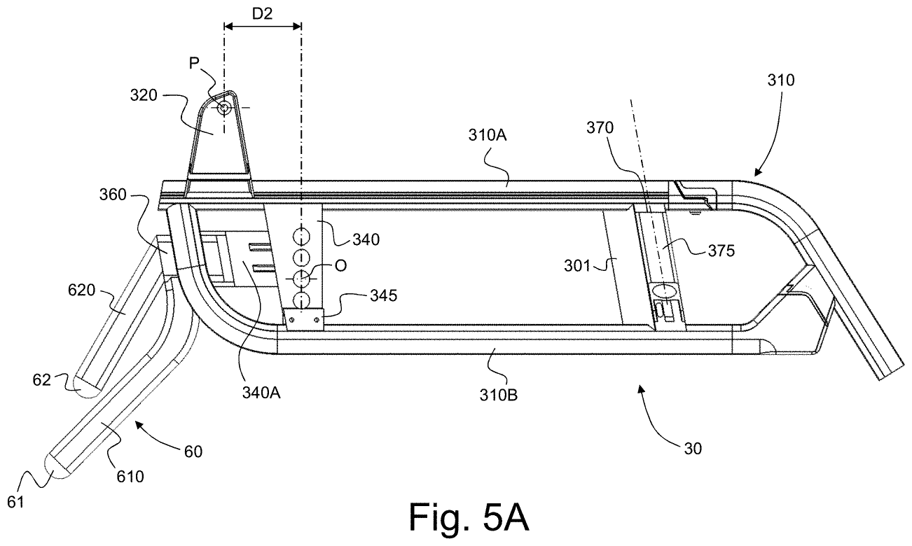

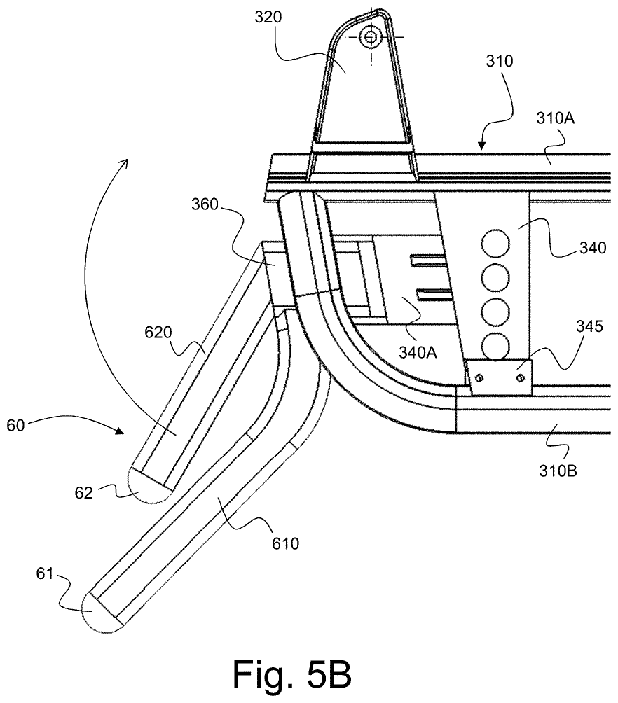

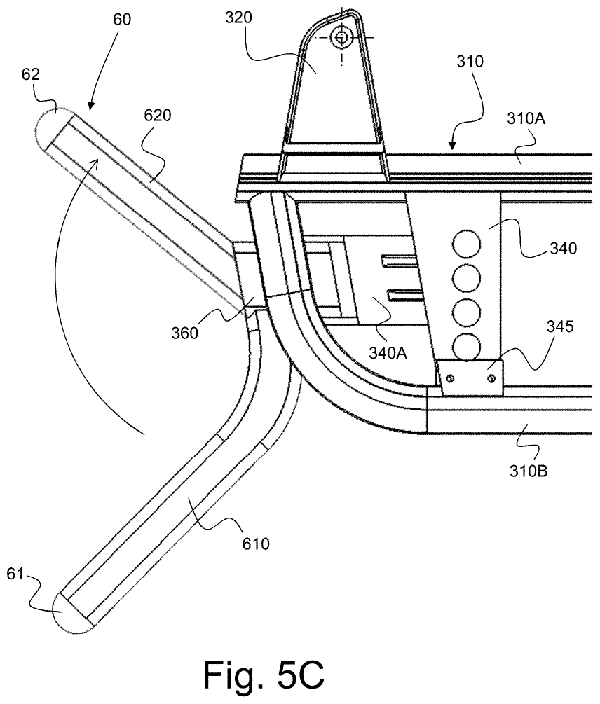

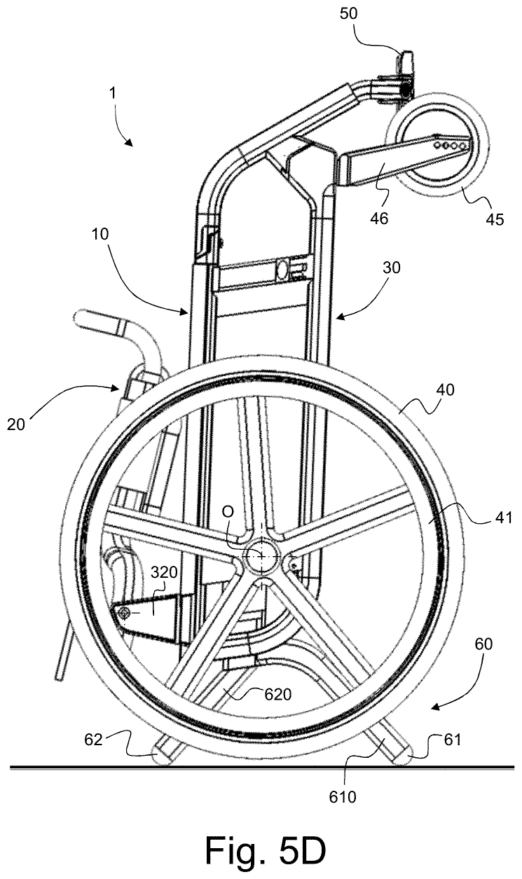

The backrest 20 preferably comprises a backrest frame 21 acting as structural element of the backrest 20, which backrest frame 21 is supported onto the wheelchair chassis 30 by means of a pair of backrest frame supports 320 that are partly visible in FIG. 2D (see also FIGS. 3A-3D, 4 and 5A-5D). Such backrest frame supports 320 are especially designed, in the illustrated embodiments, so as to allow the backrest 20 to be folded (or collapsible) frontward onto the seating area 10, as depicted for instance in FIG. 5D. The backrest frame supports 320 can in particular be designed in accordance with International Publication No. WO 2014/020378 A1, the disclosure of which is incorporated herein by reference. The relevant mounting location at which the backrest 20 is supported onto the wheelchair chassis 30 is designated in FIGS. 2D, 2E, 3B, 3C and 5A by reference P. In the illustrated embodiments, mounting location P in effect corresponds to a pivotal axis of the backrest with respect to the wheelchair chassis.

Only part of the backrest frame 21 is visible in FIGS. 1A-1B and 2A-2E, the visible part being a push handle 215 that forms an integral part of the backrest frame 21 in this embodiment. As the wheelchair chassis 30 is rigid and not foldable in the present instance, the push handle 215 can be designed as a single transverse bar connecting both sides of the backrest frame 21. The backrest frame 21 further comprises a pair of back canes (not visible in FIGS. 1A-1B and 2A-2D but designated in the following by reference numeral 210—see e.g. FIGS. 3A-3C and 4 that will be discussed more extensively in the following). These back canes 210 are each supported at a lower end onto the wheelchair chassis 30, namely via the aforementioned backrest frame supports 320.

In accordance with a preferred embodiment of the invention, as highlighted in particular by the illustration of FIG. 2C, the backrest 20 exhibits a lower backrest portion supported onto the wheelchair chassis 30, next to the seating area 10. The seating area 10 and lower backrest portion of the backrest 20 have a first width W1 that is selected to accommodate a wheelchair user's hips. The backrest 20 further exhibits an upper backrest portion, in the vicinity of the wheelchair user's shoulders, having a second width W2 that is smaller that the aforementioned first width W1, which second width W2 is selected to liberate space for movement of the wheelchair user's arms and shoulders (see also FIGS. 7A and 7B).

By way of preference, the first width W1 is selected to accommodate a wheelchair user's nominal hip width WH (see FIG. 7C) ranging between 500 millimeters and 800 millimeters, while the second width W2 is selected not to exceed a wheelchair user's nominal shoulder articulation width WS (see again FIG. 7C) ranging between 400 millimeters and 600 millimeters.

In that regard, in accordance with a particularly preferred embodiment, the second width W2 does not exceed 500 millimeters and the first width W1 is selected to exceed 500 millimeters. Advantageously, in order to match a given population of bariatric users, all wheelchairs may especially be produced with a given second width W2 of 500 millimeters and a first width W1 selected within a predetermined group of incremental widths, namely 505 millimeters, 555 millimeters, 605 millimeters, 655 millimeters, 705 millimeters and 755 millimeters or 20 inches, 22 inches, 24 inches, 26 inches, 28 inches and 30 inches.

Thanks to these dimensional considerations regarding the design of the backrest, the wheelchair user has far better mobility in the arms and shoulders, leading to better ergonomics and a greater amplitude of arm movement. Indeed, on all existing bariatric wheelchairs (as for instance depicted in FIG. 11), the backrest typically includes two vertical back canes, separated by a distance corresponding to the aforementioned wheelchair user's nominal hip width WH (as schematically illustrated by the two vertical dashed lines in FIG. 7C), which vertical back canes in effect restrain arm movement as they end up directly behind the upper portion of the wheelchair user's arms. In contrast, thanks to this preferred embodiment of the invention, space for movement of the arms and shoulders is liberated.

Tests carried out by the Applicant have demonstrated that the wheelchair user can gain approximately 20% in amplitude of movement compared to typical bariatric wheelchairs having conventional backrests. This amplitude of movement is further improved by adjusting the position of the rear wheel axis to be more frontward (compared to conventional wheelchairs), which is possible without compromising wheelchair stability as a center of gravity of overweight persons inherently shifts forward. In that respect, it is particularly advantageous to design the wheelchair in such a way that a front-to-rear position of the rear wheel axis O along the wheelchair chassis is adjustable between a plurality of selected positions so as to change a horizontal distance separating the rear wheel axis O and the mounting location P of the backrest—which horizontal distance is referred to as distance D2 in FIGS. 2D, 3B, 3C and 5A. By way of illustration, the selected positions could be such that distance D2 can be changed between the following values: 50, 75, 100 and 125 millimeters, which value are given for the purpose of illustration only. This adaptability is especially useful in order to possibly adjust the wheelchair configuration to different user weights and to the resulting shift in the user's center of gravity. The relevant wheelchair configuration for a given user can especially be selected with consideration of e.g. the normative definition of the position of the user's center of gravity pursuant to ISO norm 7176 (which position is a function of the weight of the user).

By the same token, the suppression of all armrests and armpads likewise offers greater accessibility and improved drivability for the wheelchair user.

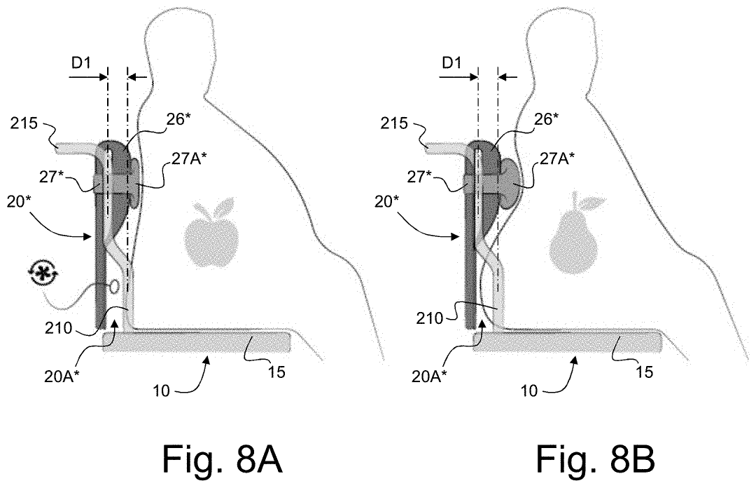

In the illustrated embodiment, the backrest 20 further comprises a backrest trim (or backrest upholstery) 25 that encloses part of the backrest frame 21, as well as a (first) cushion member 26 that is provided in the upper backrest portion of the backrest 20 to support a corresponding upper portion of the wheelchair user's dorsum. Also provided, in the illustrated embodiment, is an optional cushion belt 27 that carries an additional cushion member 27A that is designed to provide additional support for the wheelchair user's dorsum. Elements 25, 26, 27, 27A are of relevance insofar as they are used to provide adequate support for the wheelchair user's dorsum. These elements 25, 26, 27, 27A can be designed and formed in a variety of ways so as to shape and adjust a profile of the backrest 20 to ensure optimal comfort for the wheelchair user. For instance, while FIGS. 1A-1B and 2A-2E show that the lower portion of the backrest 20 sits frontward of the upper backrest portion, FIGS. 8A-8B show an alternate backrest 20*, the profile of which is such that the lower backrest portion forms a recessed area 20A* facing a lower portion of the wheelchair user's dorsum. This helps accommodating different wheelchair user's morphologies, providing space for the circulation of air if need be and for accommodating for different user morphologies (see FIGS. 8A and 8B which schematically illustrate a person with an apple-shaped morphology and a person with a pear-shaped morphology respectively). FIG. 8A-8B further illustrate that one can play with the shape of the cushion members 26*, 27A* to adjust the backrest profile to the user's morphology.

Also visible in FIGS. 1A-1B and 2A-2E is a rolling support structure 60, including a plurality of (here four) rolling elements 61, 62 provided at a terminal end of corresponding support members 610, 620 (see e.g. FIG. 2E), which rolling support structure 60 forms an integral part of the wheelchair 1. The rolling support structure 60 is mounted on a rear portion of the wheelchair 1, namely at a rear portion of the wheelchair chassis 30. The purpose of this rolling support structure 60 will be detailed later with reference to FIGS. 5A-5D.

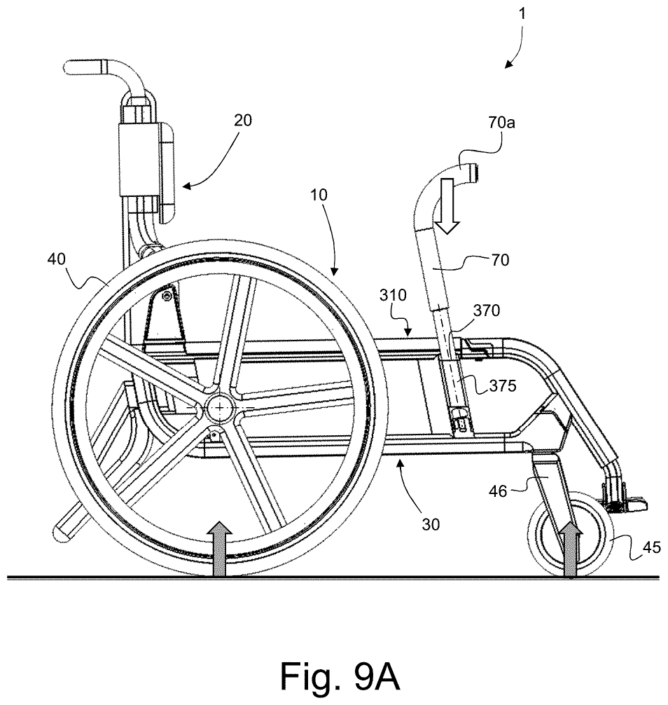

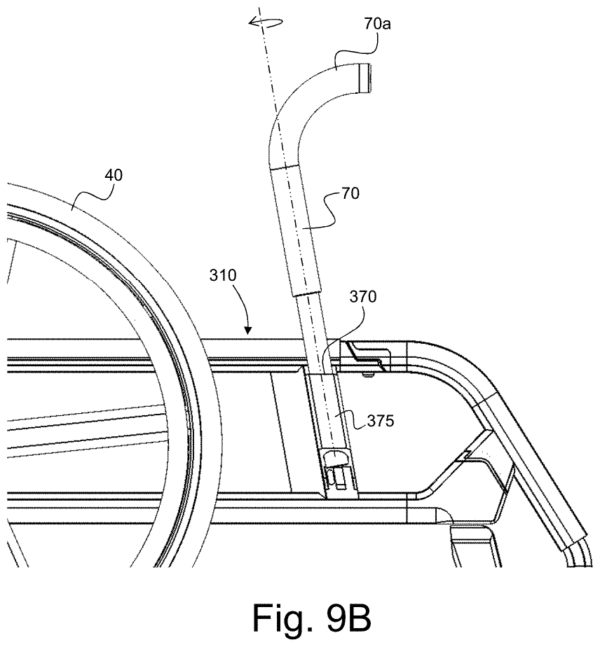

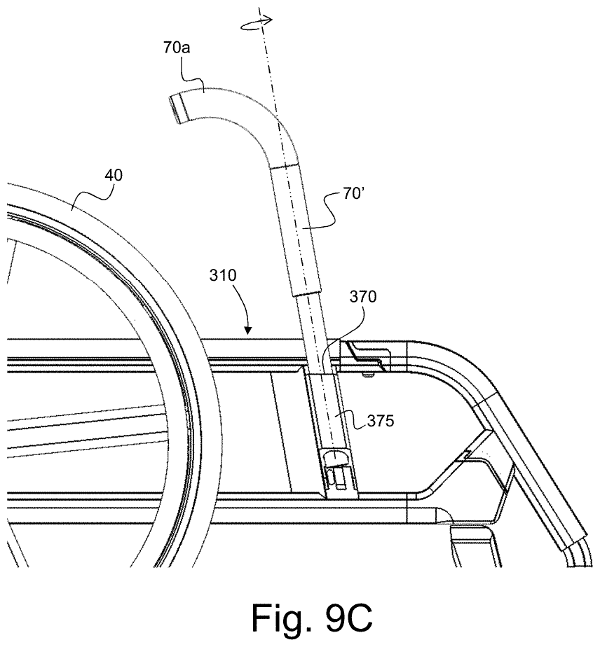

In accordance with another aspect of a preferred embodiment of the present invention, the wheelchair 1 is further provided with a pair of removable front canes 70 that are releasably supported into corresponding sockets 370 provided on the wheelchair chassis 30 next to a front part of the seating area 10. This pair of removable front canes 70 can take at least a first position (as depicted in FIGS. 1A-1B and 2A-2E) in which the removable front canes 70 act as transfer aid devices to assist the wheelchair user in raising up from or, conversely, sitting onto the seating area 10 of the wheelchair 1. As illustrated in FIGS. 1A-1B and 2A-2E, the front canes 70 each preferably exhibit a handle portion 70a that is oriented frontward, in the depicted first position of the front canes 70. Further details will be provided later in respect of these front canes 70 with reference to FIGS. 9A-9C.

FIG. 3A is a perspective view of the wheelchair 1 as seen from the same perspective as FIG. 2A, where the seat upholstery 15, backrest trim 25 and wheelchair cushions 26, 27, 27A have been omitted. FIG. 3B is likewise a perspective view of the naked wheelchair 1, stripped of elements 15, 25, 26, 27, 27A, as seen from the right-hand side, like FIG. 2D. By the same token, FIG. 3C is a perspective view of a cross-section of the naked wheelchair 1 as seen from the same perspective as FIG. 3B, which cross-section is taken along the same median plane A-A as depicted in FIG. 2C.

Components that have already been described in connection with FIGS. 1A-1B and 2A-2E will not be discussed again. One will mainly focus on the backrest frame 21 and wheelchair chassis 30 that are now more clearly visible.

Turning first to the wheelchair chassis 30, one can more clearly see the rigid configuration of the wheelchair chassis 30 with its two side frames 310 and cross members 301, 302, 303 interposed therebetween an ensuring the structural integrity and rigidity of the wheelchair chassis 30.

In the illustrated example, one can more clearly see that the sockets 370 designed to provide support for the front canes 70 are preferably formed in corresponding lateral extensions 375 (also visible in FIGS. 1A-1B and 2A-2E) on either side of the wheelchair chassis 30. These lateral extensions 375 can advantageously be an integral part of the cross member 301, thus ensuring optimal bearing for the load that could be applied via the front canes 70.

Also visible in FIGS. 3A-3C are two rear wheel supports 340 that are secured to the wheelchair chassis 30 (namely to the side frames 310) and provide support for each of the rear wheels 40. These rear wheel supports 340—which are also partly visible in FIGS. 1A-1B, 2A-2B and 2D-2E—define a position of a rear wheel axis O of the rear wheels 40.

By way of preference, a front-to-rear position of each rear wheel support 340 along the wheelchair chassis 30 (and therefore a front-to-rear position of the rear wheel axis O) is adjustable. In the illustrated example, a vertical position of the rear wheel axis O is likewise adjustable, namely thanks to the provision of a plurality of (here four) mounting locations vertically along each rear wheel support 340. In the illustrated example, the rear wheels 40 are mounted on the second mounting location starting from the lower mounting location.

Adjustment of the front-to-rear position of the rear wheel supports 340 is achieved by designing the chassis 30 so as to permit mounting of the rear wheel supports 340 at a plurality of distinct positions along each side frame 310. Only one position is depicted in the illustrations, but it should be understood that the rear wheel supports 340 could for instance be moved forward to one of multiple positions along each side frame 310. To this end, a plurality of mounting holes (not shown) are provided on a lower side of each upper frame member 310A (see FIG. 3D) and corresponding securing elements (such as screws or the like—not shown) are provided to secure the upper end of each rear wheel support 340 to the relevant mounting holes provided on the upper frame member 310A. At the lower end of each rear wheel support 340, there is provided a claw member 345 (see FIGS. 3C and 3D) that is used to clip the lower end of the rear wheel support 340 onto the lower frame member 310B of each side frame 310.

Mounting of the rear wheel supports 340 onto the wheelchair chassis 30 could be ensured in any other suitable way and it suffices, in this context, that the support of the rear wheels be such that a front-to-rear position of the rear wheel axis along the wheelchair chassis can be adjusted.

FIGS. 3C, 3D and 4 (see also FIGS. 5A-5D) further illustrate how the rolling support structure 60 is mounted onto the rear portion of the wheelchair chassis 30 in the context of this particular embodiment. As this is visible in the illustrations, each rear wheel support 340 is designed in this particular embodiment to exhibit a rear extension 340A projecting towards the rear of the wheelchair 1, which rear extension 340A is an integral part of each rear wheel support 340. Secured to this rear extension 340A is a support 360 carrying the relevant components of the rolling support structure 60, namely the lower and upper support members 610, 620 carrying the lower and upper rolling elements 61, 62, respectively.

In the illustrated embodiment, it will be appreciated that the rolling support structure 60 is mounted in such a way that any adjustment of the front-to-rear position of the rear wheel axis O of the rear wheels 40 leads to a corresponding adjustment of a front-to-rear position of the rolling support structure 60. More precisely, in the illustrated example, the rolling support structure 60 is advantageously mounted on the rear wheel supports 340 directly, and thus in a fixed relationship with respect to the front-to-rear position of the rear wheel axis O.

FIGS. 3C, 3D and 4 further illustrate that the rear cross member 303 is interposed between the rear wheel supports 340 (namely between the rear extensions 340A) and thus likewise follows any adjustment of the front-to-rear position of the rear wheel axis O. In other words, the rolling support structure 60 could, by way of alternative, be mounted on the rear cross member 303.

In the illustrated embodiment, the lower rolling elements 61 that are mounted at a terminal end of the lower support members 610 can advantageously act as anti-tip devices, i.e. devices preventing tipping of the wheelchair onto its back. The lower rolling elements 61 and associated lower support members 610 could be fixedly secured to the relevant supports 360 or be potentially foldable or retractable for storage purposes.

On the other hand, the upper rolling elements 62 that are located at a terminal end of the upper support members 620 are preferably mounted on the relevant supports 360 so as to be movable between at least a first position (as illustrated in FIGS. 1A-1B, 2A-2E, 3A-3D, 4, 5A and 5B), or storage/non-deployed position, and a working/deployed position (as illustrated in FIGS. 5C and 5D) to provide rolling support for the wheelchair 1 in an upright position in which the wheelchair 1 is titled back and supported by the rolling support structure 60, which upright position is depicted in FIG. 5D.

In the upright position depicted in FIG. 5D, and with the backrest 20 folded frontward onto the seating area 10, the wheelchair 1 exhibits a sufficiently small profile to allow the wheelchair 1 to be rolled through narrow passages, such as doorways or elevators. This is of substantial importance in the present instance as the wheelchair chassis 30 is preferably designed as a rigid chassis.

Furthermore, and as depicted in FIG. 5D, in the upright position of the wheelchair 1, the rear wheels 40 do not rest on the ground and are lifted slightly above the ground, thus allowing easy removal of the rear wheels 40 if need be, as the wheelchair user is not obliged to lift the wheelchair himself to perform such task, which would be too complicated and tiresome for the user. In that context, each rear wheel 40 is preferably mounted on the wheelchair chassis 30 by means of a quick-release mechanism, not shown, but known as such in the art. Thanks to such an arrangement, removal of the rear wheels 40 for e.g. transport purposes is greatly facilitated and can easily be performed either single-handed or with both hands being freed for that task.

In the illustrated embodiment, all of the rolling elements 61, 62 are supported onto the wheelchair chassis 30, but one could alternatively contemplate to support only part of the rolling elements 61, 62 on the wheelchair chassis 30 (e.g. the lower rolling elements 61 only), while the remaining part of the rolling elements 61, 62 (e.g. the upper rolling elements 62) could for instance be supported on the backrest 20. With such a configuration, the upper rolling elements 62 could be deployed to the working position upon folding the backrest 20 onto the seating area 10.

In accordance with a particularly preferred embodiment of the invention, the rolling elements 61, 62 are ball casters, which ensures omnidirectional rolling support for the wheelchair in the upright position. Such ball casters are known as such in the art, for instance from U.S. Pat. No. 5,455,988 A and US Patent Publication No. US 2015/0113765 A1, the disclosure of both of which is incorporated herein by reference.

The aforementioned rolling support structure 60 includes four rolling elements 61, 62, but it should be appreciated that an adequate support of the wheelchair 1 in the upright position may already been ensured using three such rolling elements. The provision of four rolling elements is however preferred in that stability of the wheelchair in the upright position is improved.

Turning back to FIGS. 3A-3C and 4, one can see the structure of the backrest frame 21 with its two back canes 210 supported onto the wheelchair chassis 30 at lower ends thereof, as well as the push handle 215 that is secured to upper ends of the two back canes 210. The push handle 215 may conveniently be secured to the upper ends of the back canes 210 so as to be adjustable in height. Also visible (see FIGS. 3C and 4) is a pair of cross members 211 interposed between the two back canes 210 and providing structural integrity to the backrest frame 21, which pair of cross members 211 are adapted to receive a backrest panel 212 (such as e.g. a wooden panel)—which backrest panel 212 has been omitted in FIG. 4.

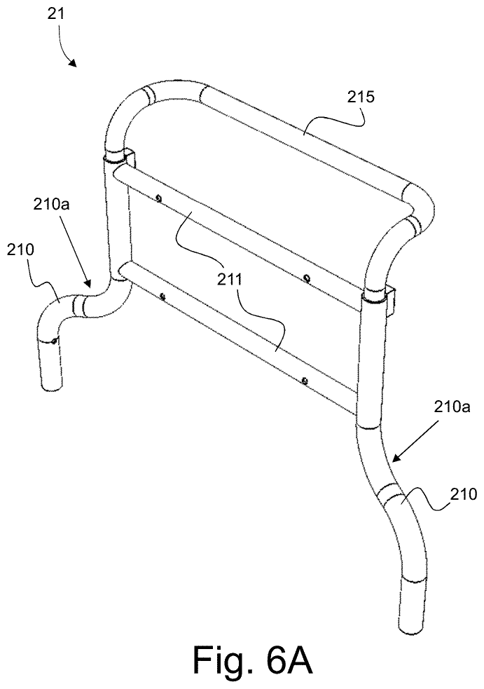

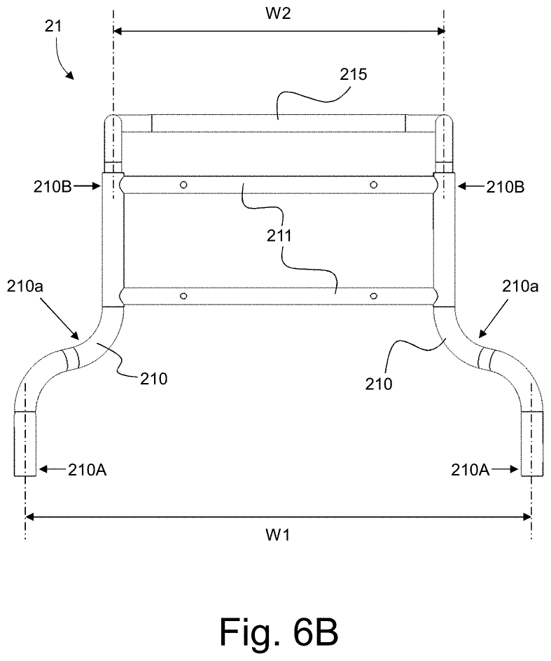

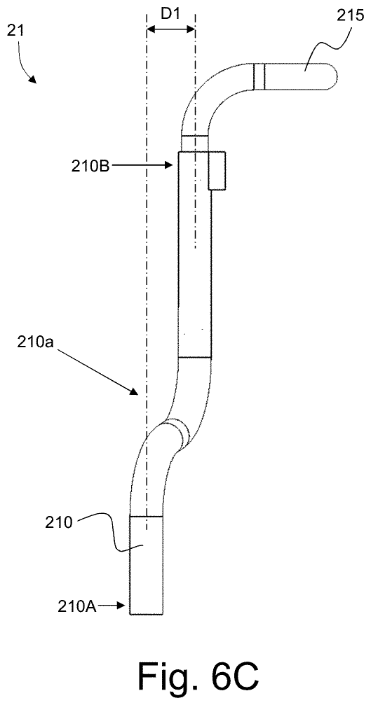

The backrest frame 21 is further shown in isolation in the illustrations of FIGS. 6A-6C. As illustrated, lower ends 210A of the back canes 210 are supported onto the wheelchair chassis 30 and are separated by the aforementioned first width W1. The back canes 210 are furthermore curved inwardly so that upper ends 210B thereof, in the vicinity of the wheelchair user's shoulders, are separated by the second width W2. In other words, the back canes 210 each exhibit an inwardly-curved section 210a where the backrest frame 21 transitions from a lower frame portion (corresponding to the lower backrest portion of backrest 20) to an upper frame portion (corresponding to the upper backrest portion of backrest 20).

Looking at the backrest frame 21 from the side, as illustrated in FIG. 6C, one can note that the backrest frame 21 further exhibits an offset between the upper and lower frame portions, the upper frame portion sitting rearward of the lower frame portion. The upper and lower frame portions are preferably offset by a distance D1 ranging between 50 millimeters and 100 millimeters. This offset advantageously provides more room to play with the backrest profile and incorporate varying sizes of cushions as depicted e.g. in FIGS. 8A and 8B.

The backrest and backrest frame could be designed in any suitable way to match the overall dimensional requirements mentioned above. FIGS. 7A and 7B for instance show another wheelchair 1′ in accordance with another embodiment of the present invention having a backrest 20′ comprising a backrest frame including two back canes 210′ (which could in essence be similar to the back canes 210 shown in FIGS. 3A-3C, 4 and 6A-6C) with the difference that upper ends thereof are further curved rearwardly to form a pair of push handles 215′.

A positive effect resulting from the aforementioned dimensional considerations regarding the design of the backrest (besides providing better ergonomics and improving the amplitude of arm movement) also resides in the overall improvement of the wheelchair aesthetics and look. Indeed, the “slimmed” backrest design provides a far better general look and feel to the overall wheelchair which appears visually less bulky than conventional bariatric wheelchair. This is a non-negligible aspect for the relevant wheelchair users. As a matter of fact, the backrest of the invention gives the visual impression of a wheelchair that would be smaller than it actually is, which is a very positive and important element for bariatric users.

Turning now to FIGS. 9A-9C, one will further discuss the relevance and usefulness of the pair of removable front canes 70 that are releasably supported in the corresponding sockets 370 provided on the wheelchair chassis 30, next to the front part of the seating area.

As already mentioned, the pair of removable front canes 70 can take at least a first position, as depicted in FIGS. 1A-1B, 2A-2E, 9A and 9B, in which the removable front canes 70 are oriented with the handle portion 70a facing frontward. In this position the front canes 70 can be used by the wheelchair user as transfer aid devices to assist the wheelchair user in raising up from or, conversely, sitting onto the seating area 10 of the wheelchair 1. By doing so, the wheelchair user applies load to the handle portion 70a of the front canes 70, which ensures optimal support and stability for the wheelchair user, the applied load being adequately distributed amongst the four contact points between the ground and the wheels 40, 45.

The front canes 70 are advantageously adjustable in height with respect to the wheelchair chassis 30 in order to accommodate for different user's morphologies, which can be ensured by an adequate support of the front canes 70 into the relevant sockets 370.

As further illustrated in FIG. 9C, the removable front canes 70 are preferably reversible and can take at least a second position, opposite to the first position, with the handle portion 70a facing rearward. In FIG. 9C, the front canes are designated by reference numeral 70′ for the sake of differentiation. In this position, the front canes 70′ thus also act as forearm supports for the wheelchair user. This arrangement is also beneficial in that, in the second position, the front canes 70′ do not prevent the user from getting closer e.g. to a table or desk.

The removable front canes 70 are preferably designed so as to be insertable from above into the corresponding sockets 370, and can be removed entirely in case of necessity, especially during transport of the wheelchair e.g. in the upright position depicted in FIG. 5D.

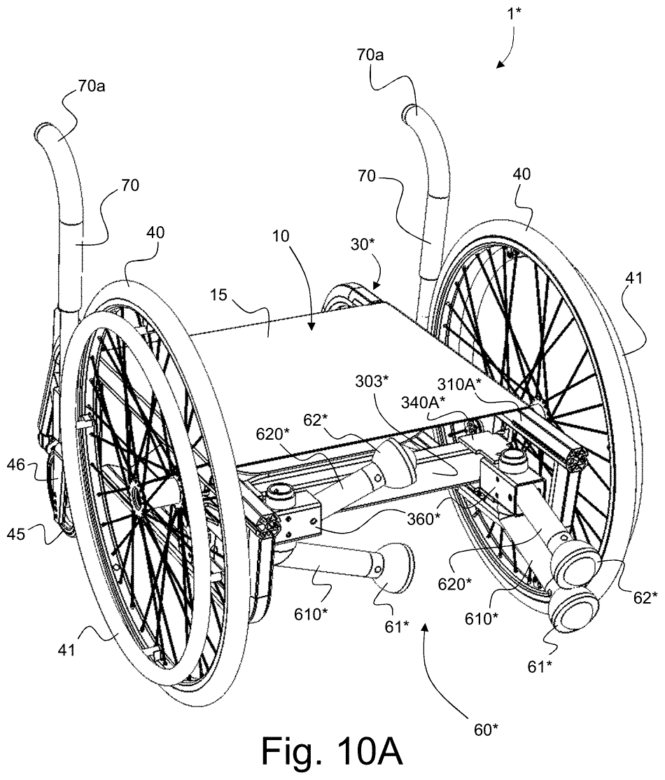

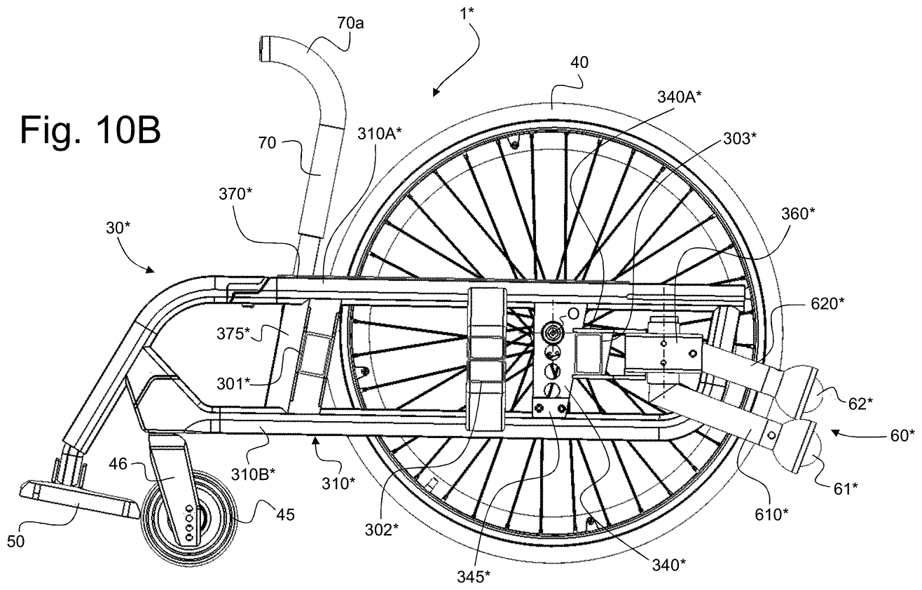

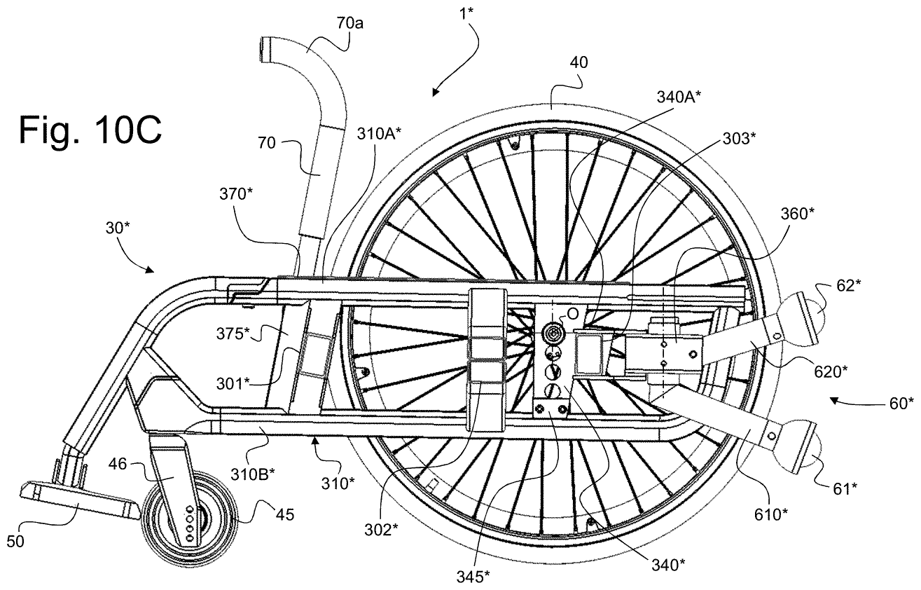

FIGS. 10A to 100 are respectively a perspective view and two cross-sectional views of a wheelchair 1* in accordance with another embodiment of the invention. In FIGS. 10A to 10C, the wheelchair backrest has been omitted and could in essence be identical to the backrest 20 of wheelchair 1.

The wheelchair 1* comprises a wheelchair chassis 30* that differs slightly from the wheelchair chassis 30 of wheelchair 1, but likewise comprises two side frames 310* and three cross members 301*, 302*, 303* interposed therebetween. One difference may be noted in respect of the middle cross member 302* that is interposed between the side frames 310* and connects both the upper and lower frame members thereof 310A*, 310B* in this other embodiment, rather than only the lower frame members.

The wheelchair chassis 30* likewise comprises a pair of rear wheel supports 340* supporting the rear wheels 40 (here at the upper mounting location), which rear wheel supports are secured to each side frame 310* between the upper and lower frame members 310A*, 310B* by means of adequate securing elements, including a claw member 345* used to clip the lower end of the rear wheel support 340* onto the lower frame member 310B*. In this other embodiment, the rear wheel supports 340* are shown as being mounted at a more forward position on the wheelchair chassis 30* compared to the previous embodiment.

Each rear wheel support 340* likewise comprises a rear extension 340A* forming an integral part thereof, which extension 340* is used to secure a support 360* carrying the rolling support structure 60*. The rear cross member 303* is similarly interposed between the rear wheel supports 340*, namely between the rear extensions 340A*.

FIG. 10A illustrates that each support 360* can be pivoted about a vertical axis so as to move the associated elements 61*, 610*, 62*, 620* of the rolling support structure 60* between a retracted storage position (shown on the left-hand side of FIG. 10A) and a (partly) deployed working position (shown on the right-hand side of FIG. 10A). The rolling support structure 60* can thus be fully retracted to a storage position behind and underneath the wheelchair 1* if need be.

FIGS. 10B and 100 respectively show the rolling support structure 60* in partly and fully deployed configurations. In the partly deployed configuration, the lower rolling elements 61* and associated supporting members 610* take a position where they can act as anti-tip devices, as in the previous embodiment. In this first configuration, the upper rolling elements 62* and associated supporting members 620* are not fully deployed as they are not particularly exploited when the wheelchair 1* is being wheeled normally on its front and rear wheels 40, 45. In the fully deployed configuration, the upper rolling elements 62* and associated supporting members 620* are moved to an upper, working position, much like the upper rolling elements 62 and associated supporting members 620 of the previous embodiment. In this fully deployed configuration, the wheelchair 1* can once again be tilted back to an upright position and be supported by the rolling support structure 60* to allow displacement of the wheelchair in the upright position. The rolling elements 61*, 62* are once again preferably ball casters, which ensures omnidirectional rolling support for the wheelchair 1* in the upright position.

Various modifications and/or improvements may be made to the above-described embodiments without departing from the scope of the invention as defined by the annexed claims. For instance, other elements could be contemplated in order to act as rolling elements for the rolling support structure. Ball casters are particularly preferred in that they ensure omnidirectional rolling support of the wheelchair in the upright position, but a combination of more conventional casters could also be contemplated.

Furthermore, although the embodiments disclosed herein show wheelchairs equipped with a backrest comprising a backrest frame and backrest trim enclosing at least partly the backrest frame, other backrest configurations could be contemplated.

In addition, while the disclosed embodiments all relate to purely manual wheelchairs, power-assisted means could additionally be provided to help, support or otherwise assist propulsion of the wheelchair, including electric motors or the like.

### LIST OF REFERENCE NUMERALS AND SIGNS USED THEREIN

1 wheelchair (first embodiment)
1′ wheelchair (alternate embodiment
1* wheelchair (alternate embodiment)
   10 wheelchair seating area
15 self-supporting seat upholstery
20 (foldable) wheelchair backrest (first embodiment)
21 backrest frame
210 back canes (part of backrest frame 21)
210a inwardly curved section of back canes 210 (also preferably curved rearwardly)
210A lower end of back canes 210
210B upper end of back canes 210
211 cross members (part of backrest frame 21)
212 backrest panel (e.g. wooden panel—secured to cross members 210)
215 push handle (part of backrest frame 21)
25 backrest trim
26 backrest cushion
27 cushion belt for additional backrest cushion
27A additional backrest cushion
20′ (foldable) wheelchair backrest (alternate embodiment)
210′ back canes of backrest 20′
215′ push handle (part of back canes 210′)
20* (foldable) wheelchair backrest (alternate embodiment)
20A* recessed area in lower backrest portion of backrest 20*
26* backrest cushion
27* cushion belt for additional backrest cushion
27A* additional backrest cushion
30 wheelchair chassis (first embodiment)
301 front cross member (part of wheelchair chassis 30)
302 central cross member (part of wheelchair chassis 30)
303 rear cross member (secured to adjustable rear wheel supports 340)
310 side frames (part of wheelchair chassis 30)
310A upper frame member (part of side frame 310)
310B lower frame member (part of side frame 310)
320 backrest frame supports (part of wheelchair chassis 30)
340 adjustable rear wheel supports (secured to wheelchair chassis 30)
340A rear extension of adjustable rear wheel supports 340 for securing rear cross member 303 and support 360
345 claw members for securing lower end of adjustable rear wheel supports 340 to wheelchair chassis 30, namely to lower frame member 310B
360 support for rolling support structure 60 (secured to adjustable rear wheel supports 340—first embodiment)
370 sockets for front canes 70
375 lateral extensions of wheelchair chassis 30 provided with sockets 370
30* wheelchair chassis (second embodiment)
301* front cross member (part of wheelchair chassis 30*)
302* central cross member (part of wheelchair chassis 30*)
303* rear cross member (secured to adjustable rear wheel supports 340*)
310* side frames (part of wheelchair chassis 30*)
310A* upper frame member (part of side frame 310*)
310B* lower frame member (part of side frame 310*)
340* adjustable rear wheel supports (secured to wheelchair chassis 30*)
340A* rear extension of adjustable rear wheel supports 340* for securing rear cross member 303* and support 360*
345* claw members for securing lower end of adjustable rear wheel supports 340* to wheelchair chassis 30*, namely to lower frame member 310B*
360* support for rolling support structure 60* (secured to adjustable rear wheel supports 340—second embodiment)
370* sockets for front canes 70
375* lateral extensions of wheelchair chassis 30* provided with sockets 370*
40 rear wheels
41 hand rims
O rear wheel axis
45 front wheels
46 pivotable front wheel supports (or forks)
50 footrests
60 rolling support structure (first embodiment)
61 (lower) rolling elements (e.g. ball casters) of rolling support structure 60—also acting as anti-tip members
62 (upper) rolling elements (e.g. ball casters) of rolling support structure 60
610 (lower) support members for lower rolling elements 61
620 (upper) support members for upper rolling elements 62
60* rolling support structure (second embodiment)
61* (lower) rolling elements (e.g. ball casters) of rolling support structure 60*—also acting as anti-tip members
62* (upper) rolling elements (e.g. ball casters) of rolling support structure 60*
610* (lower) support members for lower rolling elements 61*
620* (upper) support members for upper rolling elements 62*
70 reversible front canes shown in first position, acting as transfer aid devices
70′ front canes 70 shown in reversed position, acting as forearm supports
70a handle portion of front canes 70
W1 width of lower portion of backrest 20, 20′, 20*, in the vicinity of the seating area 10/distance separating lower ends 210A of back canes 210 (selected with consideration of wheelchair user's nominal hip width)
W2 width of upper portion of backrest 20, 20′, 20*, in the vicinity of the wheelchair user's shoulders/distance separating upper ends 210B of back canes 210 (selected with consideration of wheelchair user's nominal shoulder articulation width)
WH wheelchair user's nominal hip width (preferably ranging between 500 millimeters and 800 millimeters)
WS wheelchair user's nominal shoulder articulation width (preferably ranging between 400 millimeters and 600 millimeters)
D1 distance separating lower frame portion of backrest frame 21 (lower ends 210A of back canes 210) and upper frame portion of backrest frame 21 (upper ends 210B of back canes 210—selected with consideration of wheelchair user's dorsum morphology)
P mounting location at which the backrest is supported onto the wheelchair chassis/pivotal axis of backrest with respect to wheelchair chassis
D2 horizontal distance separating the rear wheel axis O of the rear wheels 40 and the mounting location P

1-24. (canceled)

25. A wheelchair comprising a wheelchair chassis, a seating area provided on the wheelchair chassis, a backrest supported onto the wheelchair chassis, as well as front wheels and rear wheels provided on the wheelchair chassis to allow wheeling of the wheelchair,
wherein the wheelchair further comprises a rolling support structure forming an integral part of the wheelchair, which rolling support structure is mounted on a rear portion of the wheelchair to support the wheelchair in an upright position in which the wheelchair is tilted back and is supported by the rolling support structure to allow displacement of the wheelchair in the upright position, which rolling support structure includes at least three rolling elements providing rolling support for the wheelchair in the upright position.

26. The wheelchair according to claim 25, wherein the rolling support structure includes four rolling elements.

27. The wheelchair according to claim 25, wherein the rolling elements provide omnidirectional rolling support for the wheelchair in the upright position.

28. The wheelchair according to claim 27, wherein the rolling elements are ball casters.

29. The wheelchair according to claim 25, wherein at least part of the rolling elements are supported onto the wheelchair chassis.

30. The wheelchair according to claim 29, wherein all of the rolling elements are supported onto the wheelchair chassis.

31. The wheelchair according to claim 25, wherein, in the upright position of the wheelchair, the rear wheels do not rest on the ground.

32. The wheelchair according to claim 31, wherein each rear wheel is mounted on the wheelchair chassis by means of a quick-release mechanism.

33. The wheelchair according to claim 25, wherein the rolling support structure is at least partly deployable between a storage position at a rear portion of the wheelchair chassis and a working position where the rolling elements are fully deployed to provide rolling support for the wheelchair in the upright position.

34. The wheelchair according to claim 25, wherein the rolling elements include at least a pair of lower rolling elements that also act as anti-tip devices.

35. The wheelchair according to claim 25, wherein a front-to-rear position of a rear-wheel axis of the rear wheels along the wheelchair chassis is adjustable and wherein the rolling support structure is mounted in such a way that any adjustment of the front-to-rear position of the rear-wheel axis of the rear wheels leads to a corresponding adjustment of a front-to-rear position of the rolling support structure.

36. The wheelchair according to claim 35, wherein the rolling support structure is mounted in a fixed relationship with respect to the front-to-rear position of the rear-wheel axis.

37. The wheelchair according to claim 25, wherein the wheelchair chassis is designed as a rigid, non-foldable chassis and is made of lightweight materials.

38. The wheelchair according to claim 37, wherein the backrest is foldable frontward onto the seating area.

39. The wheelchair according to claim 37, wherein the wheelchair chassis is made of aluminum.

40. The wheelchair according to claim 35, wherein the wheelchair chassis is designed as a rigid, non-foldable chassis,
wherein the wheelchair chassis comprises side frames provided on left and right sides of the wheelchair chassis, each comprising a rear wheel support to support a corresponding one of the rear wheels at a position defining the rear-wheel axis,
wherein a front-to-rear position of the rear wheel support along each side frame, and therefore the front-to-rear position of the rear-wheel axis, is adjustable,
and wherein the rolling support structure is mounted in a fixed relationship with respect to the front-to-rear position the rear-wheel axis.

41. The wheelchair according to claim 40, wherein the rolling support structure is mounted directly onto the rear wheel supports or onto a rear cross member of the wheelchair chassis, which rear cross member is interposed between the rear wheel supports.

42. The wheelchair according to claim 25, wherein the backrest exhibits a lower backrest portion supported onto the wheelchair chassis, next to the seating area, the seating area and lower backrest portion having a first width that is selected to accommodate a wheelchair user's hips,
and wherein the backrest further exhibits an upper backrest portion, in the vicinity of the wheelchair user's shoulders, having a second width that is smaller than the first width, which second width is selected to liberate space for movement of the wheelchair user's arms and shoulders.

43. The wheelchair according to claim 42, wherein the first width is selected to accommodate a wheelchair user's nominal hip width ranging between 500 millimeters and 800 millimeters and wherein the second width is selected so as not to exceed a wheelchair user's nominal shoulder articulation width ranging between 400 millimeters and 600 millimeters.

44. The wheelchair according to claim 43, wherein the second width does not exceed 500 millimeters and wherein the first width is selected to exceed 500 millimeters.

45. The wheelchair according to claim 42, wherein the backrest comprises a backrest frame acting as structural element of the backrest, which backrest frame is shaped to exhibit lower and upper frame portions supporting respectively the lower and upper backrest portions.

46. The wheelchair according to claim 45, wherein the backrest frame includes a pair of back canes having lower ends supported onto the wheelchair chassis and being separated by the first width, which back canes are curved inwardly so that upper ends thereof, in the vicinity of the wheelchair user's shoulders, are separated by the second width.

47. The wheelchair according to claim 25, further comprising a pair of removable front canes supported into corresponding sockets provided on the wheelchair chassis next to a front part of the seating area, which pair of removable front canes can take at least a first position in which the removable front canes act as transfer aid devices for assisting the wheelchair user in raising up from or, conversely, sitting onto the seating area of the wheelchair, each removable front cane exhibiting a handle portion that is oriented frontward, in the first position.

48. The wheelchair according to claim 47, wherein the removable front canes are reversible and can take at least a second position, opposite to the first position, with the handle portion being oriented rearward, to act as forearm supports for the wheelchair user.

49. The wheelchair according to claim 25, wherein the wheelchair is a manual wheelchair for bariatric or heavy-duty use.
